(19) United States
(12) Patent Application Publication
(10) Pub. No.: US 2006/0249235 A1
(43) Pub. Date: Nov. 9, 2006

(54) Run-flat support

(75) Inventor: Jean-Charles Lacour, Clermont-Ferrand (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/416,713

(22) Filed: May 3, 2006

(30) Foreign Application Priority Data
May 3, 2005 (FR) 05/04481

(51) Int. Cl. B60C 5/00

(52) U.S. Cl. 152/158

(57) ABSTRACT

Run-flat support (1, 2) adapted to be mounted on a rim inside a tire, comprising a substantially cylindrical base (100) adapted to fit around the rim, a substantially cylindrical crown (101) and an annular body (102) linking the base and the crown. The body is composed of a plurality of generally radial partitions (103) distributed over the circumference of the support and of generally radial junctions (106) extending circumferentially and connected by their ends to two adjacent partitions. These junctions (106) are interrupted by very narrow axial incisions (104) extending radially over the entirety of the junction and opening axially on either side of the junction.

### FIELD OF THE INVENTION

The present invention relates to run-flat supports for vehicle tires, intended to be mounted on the rims thereof inside the tires, to support the load in the event of tire failure or abnormally low pressure.

It relates more particularly to “structural” run-flat supports, generally made from an elastomeric material and comprising:
a substantially cylindrical base, intended to conform to the rim;
a substantially cylindrical crown intended to enter into contact with the internal part of the tire situated under the tread in the event of a loss of pressure and leaving clearance relative thereto at the rated operating pressure of the tire; and
an annular body linking the base and the crown, said body having a plurality of generally radial partitions, extending axially on either side of a circumferential median plane and distributed over the circumference of said supports. These partitions may be connected in pairs by junction elements extending substantially circumferentially.

### BACKGROUND OF THE INVENTION

Numerous publications describe the profiles and arrangement of these partitions and these junction elements.

Publication U.S. Pat. No. 4,248,286 discloses a support comprising substantially axial partitions not linked by circumferential junction elements.

Publications EP 796 747, JP3082601, WO 00/76791 exhibit partition profiles linked together by continuous, substantially circumferential junctions. These junction elements may be situated on one and the same side of a median plane, or alternately on either side of the median plane; likewise, the geometry of the partitions may be adapted in the central portion thereof to resist buckling under radial loading of the annular body. These annular body profiles have the advantage over the above-cited publication U.S. Pat. No. 4,248,286 of increasing very significantly the structural rigidity of the annular body and consequently making it possible to lighten considerably the mass of the run-flat support for an identical load and a given material. It should be noted that reducing the weight of non-suspended rolling assemblies is of major significance with regard to vehicle performance and therefore lightening of the support is of prime importance.

Under flat running or low pressure conditions, the partitions of the support undergo limited crushing in the contact patch between the ground and the tire through the action of the portion of the weight of the vehicle applied to this rolling assembly and the dynamic loads which this same rolling assembly suffers when the vehicle changes direction. It should be noted that the flat running performance of the vehicle depends in part on the shape of this contact patch. For this operating mode, it is thus sought to prevent collapse of the support on itself, which would cause buckling of the partitions under the action of an excessive load. If this were to happen, the support would lose much of its functionality and in particular would see its endurance performance decrease spectacularly as a result of the heating caused by repeated flexion of the partitions.

However, although run-flat supports are designed inter alia to meet flat running conditions, such conditions happily remain very unusual. It is in fact desirable for the arrangement to be such that the support does not disturb operation of the tire under normal usage conditions and at rated pressure. This could be the case if the vehicle accidentally meets with a localized obstacle, such as a pothole or a kerb, at an excessively high speed. In fact, when such an accidental event takes place, the obstacle acts like a wedge and compresses the tire locally, causing deformation of the latter. The radial course of this deformation varies as a function of the overall quantity of energy to be absorbed, which depends primarily on the speed and mass of the vehicle at the moment of impact and on the shape of the localized obstacle.

This deformation comprises three very distinct phases:
a purely pneumatic phase corresponding to compression of the tire until the internal surface of the fire comes into contact with the support,
a combined phase during which, as the tire continues to be compressed, the partitions of the support situated at the level of the impact in turn become compressed and then, when the buckling threshold of the partitions is reached, collapse on themselves,
finally, a non-pneumatic phase when the assembly consisting of the tire and the support is compressed on itself and forms a solid resilient assembly to the extent of constituting an incompressible assembly. Ultimately, absorption of this energy may result in permanent deformation of the mechanical elements themselves.

Incorporation of a run-flat support into a tire is thus liable substantially to reduce the purely pneumatic phase in the event of impact, compared with the situation in which no run-flat support has been introduced onto the rim. It will be observed that, during the phase of compression of the partitions, which takes place at the start of the combined phase, deformation is slight and absorbs a large amount of energy, which causes discomfort for the vehicle passenger and greatly stresses the mechanical components of the vehicle.

When supports are being designed, therefore, it is sought to improve this level of performance.

### SUMMARY OF THE INVENTION

A first solution consists in increasing support clearance, which comes down to reducing the height of said support. Nevertheless, this cannot be done without also considerably reducing flat running performance, due to the increase in flexion of the sidewalls of the tire in this configuration.

The invention makes it possible to provide run-flat supports of equivalent mass and exhibiting the same flat running performance as the structural supports described above, but having the special feature of lowering the buckling threshold of the partitions in controlled manner, in the event of accidental impact of the kerb or pothole impact type. This results in a significant reduction in the energy transmitted to the chassis, so improving passenger comfort.

According to a first embodiment, the invention proposes a run-flat support intended to be mounted on a rim inside a tire fitted on a vehicle, to support the tread of said tire in the event of a loss of inflation pressure, comprising:
a substantially cylindrical base, intended to conform to the rim,
a substantially cylindrical crown intended to enter into contact with the internal part of the tire situated under the tread in the event of a loss of pressure and leaving clearance relative thereto at the rated operating pressure of the tire, and
an annular body linking the base and the crown, said body having a plurality of generally radial partitions, distributed over the circumference of said support and extending substantially axially, and of generally radial junctions, extending substantially circumferentially and connected by their ends to two adjacent partitions,
   wherein the junctions are interrupted by very narrow axial incisions extending radially over the entirety of said junction and opening axially on either side of the junction, the support portion between two incisions constituting a segment, and in that, each incision being geometrically defined by a transverse profile obtained by cutting said incision through a cutting plane substantially transverse to the average direction of the incision, the transverse profile has on its radial end curves (p) greater than one mm.

It has emerged that the presence of this narrow incision brings about virtually no disruption to operation of the support in flat running mode, the latter behaving substantially like a similar standard support with continuous junctions. On the other hand, however, the partitions of a support according to the invention “move aside” more readily under the action of a punctiform impact than conventional supports. The fact that the incisions have at their radial end or ends a transverse profile with a curve greater than 1 mm makes it possible to obtain an excellent fatigue behavior of these ends. In fact, it was observed that with smaller curves, for example on the order of 0.5 mm, fissures may gradually appear at these radial ends of the incisions when running flat or upon repeated impacts, for example on wedge-like obstacles.

It is advantageous for these curves to be between:

$$\frac{d}{2} ≺ ρ ≺ d$$

where d is the transverse width of the incisions.

In order to lower still further the buckling threshold of the partitions, it is possible, in a second embodiment, to extend the incision radially over all or some of the crown.

### BRIEF DESCRIPTION OF THE DRAWINGS

The mode of operation of a run-flat support according to the invention and the various embodiments according to the invention are described below with reference to diagrams and drawings in which:

FIG. 1 shows a simplified schematic perspective view of a run-flat support according to the invention,

FIG. 2 is a front view of a support portion as shown in FIG. 1,

FIG. 3 is a sectional view taken along line FF′ of the support portion as shown in FIG. 2,

FIG. 4 is a perspective view of the support portion shown in FIGS. 2 and 3,

FIG. 5 is a partial schematic view of a support functioning under reduced pressure,

FIG. 6 is a partial schematic view of a support in the event of impact,

FIG. 7 shows a diagram comparing the forces recorded at the wheel centre, as a function of the deformation caused by an isolated obstacle, of a rolling assembly consisting of a tire mounted on a rim and comprising a run-flat support and inflated to its rated pressure,

FIG. 8 is a simplified schematic perspective view of a run-flat support according to a second embodiment of the invention,

FIG. 9 is a front view of a support portion as shown in FIG. 8,

FIG. 10 is a sectional view taken along line GG′ of the support portion as shown in FIG. 9,

FIG. 11 is a perspective view of the support portion shown in FIGS. 9 and 10,

FIG. 12 is a partial schematic view of a support according to a second embodiment of the invention, functioning under reduced pressure,

FIG. 13 is a partial schematic view of a support according to a second embodiment of the invention, in the event of impact, and

FIG. 14 shows a cross-section of the radial end of an incision.

### DETAILED DESCRIPTION OF THE DRAWINGS

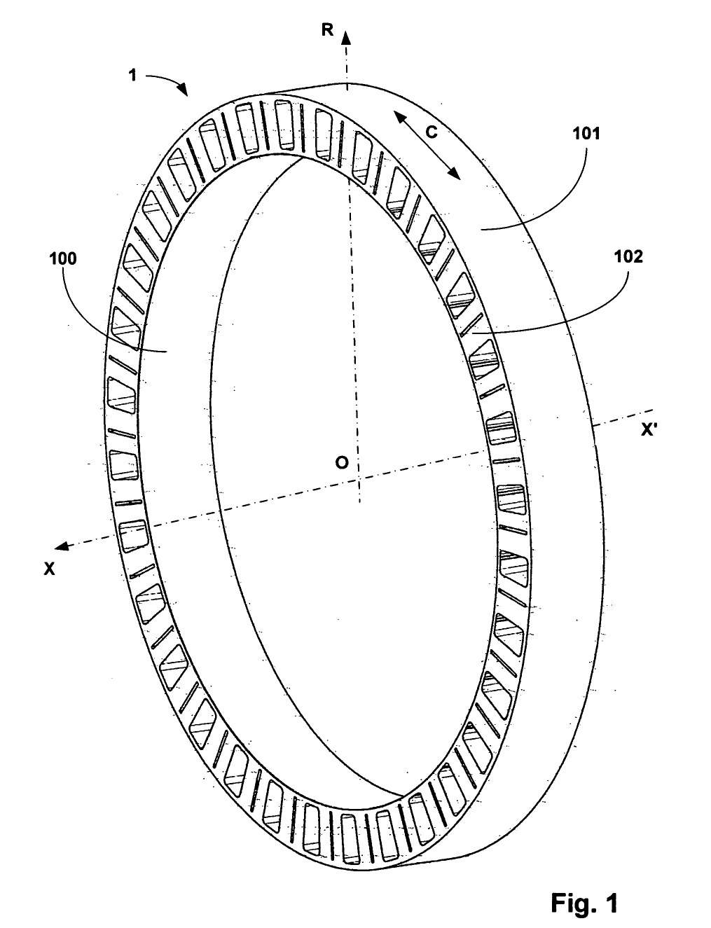

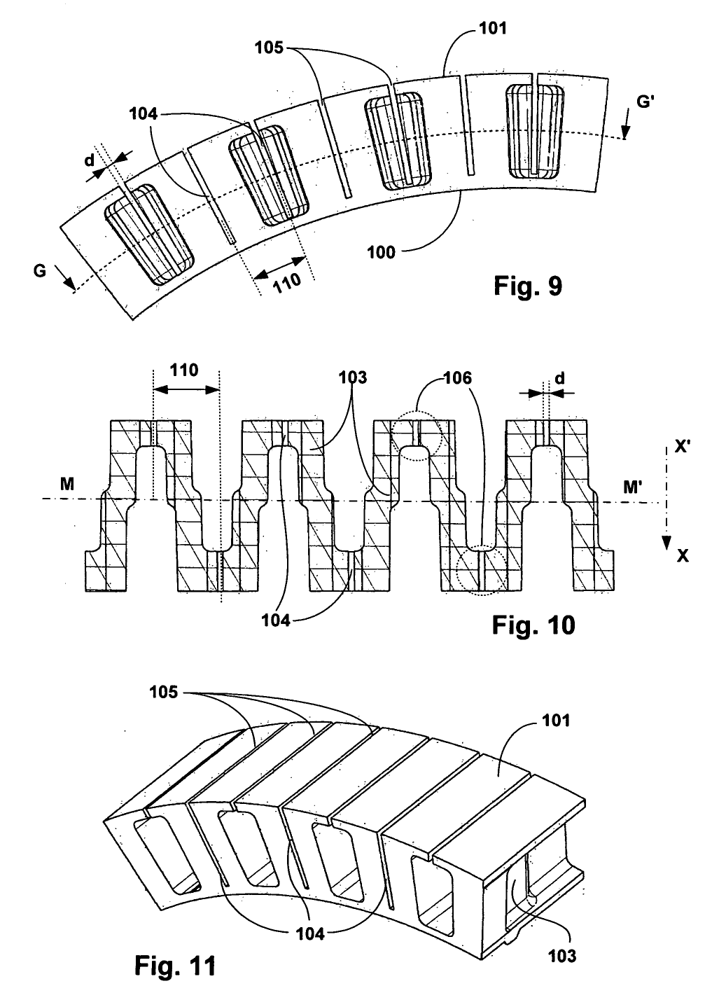

Identical elements of the supports shown in FIGS. 1 to 13 will be designated below by the same reference numerals.

The support 1 as shown in the schematic view of FIG. 1 comprises a substantially cylindrical base 100 intended to conform to a rim (not shown), a crown 101, intended to enter into contact with the internal part of the tire situated under the tread in the event of pressure loss, and a body 102 linking the base to the crown.

The axial direction XX′ is a direction substantially parallel to the generatrices of the cylinders formed by the base or the crown. The radial direction R is a direction perpendicular to the axial direction, and the circumferential direction C is perpendicular to the previous two directions and tangent to the cylinders formed by the base or the crown.

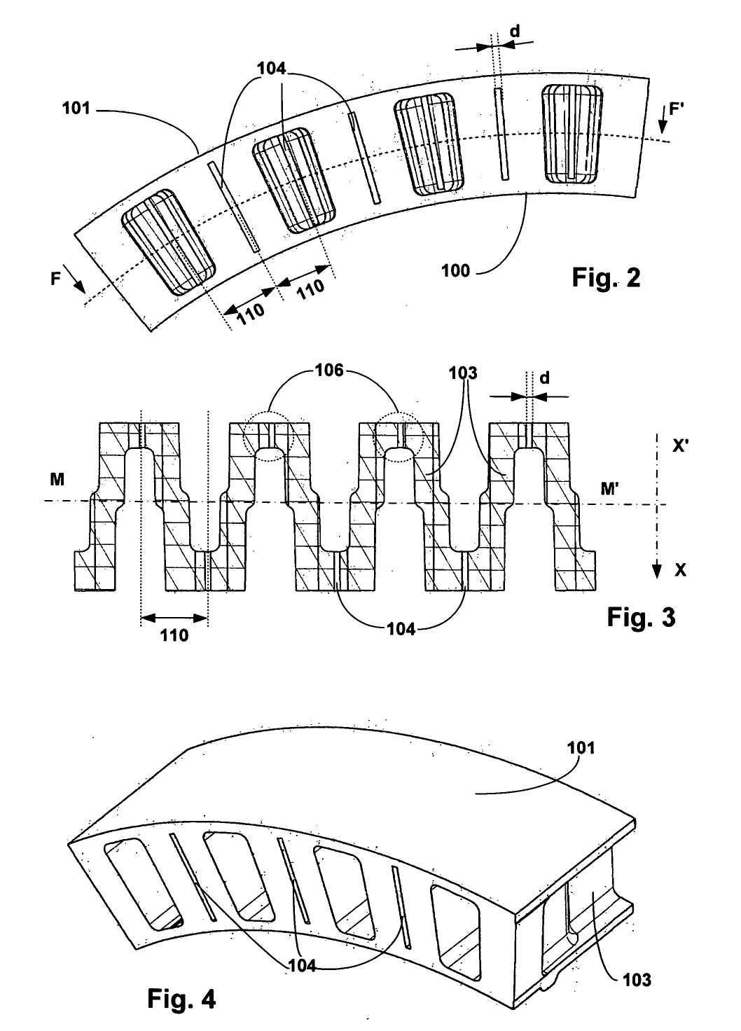

The body of the annular support 102 is made up of partitions 103 such as those illustrated in FIGS. 2 and 3. These, generally radial, partitions 103 extend axially either side of a median plane perpendicular to the axis XX′, passing substantially through the equator of the cylinders formed by the base 100 or the crown 101 and whose path is represented on the section of FIG. 3 by the line MM′. The partitions are distributed over the circumference of said support 1. Generally radial junctions 106 extending substantially circumferentially connect two adjacent partitions by their ends.

These junctions 106 are interrupted by axial incisions 104, extending radially over the entirety of the junction and opening axially on either side of said junction. The support portion between two incisions constitutes a segment 110.

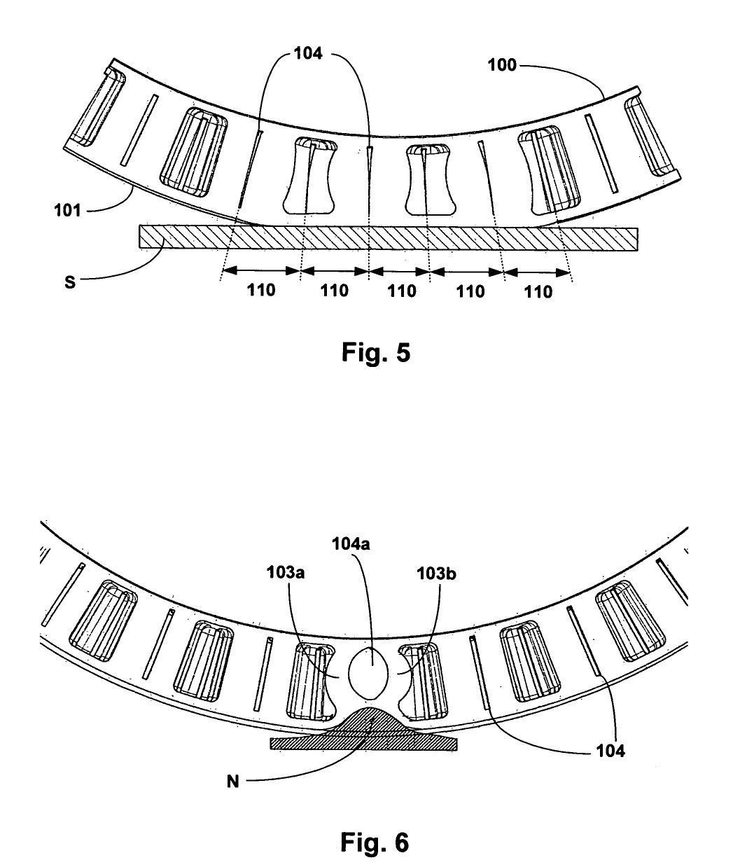

FIG. 5 is a schematic representation of the mode of operation, at the level of the contact patch, of the support 1 at reduced or even zero pressure and run-flat its rated load. The radial compression forces generate a circumferential component at the level of the segments 110 in contact with the tire portion in contact with the ground S. These forces are associated with deradialisation of the crown 101 of the support due to the effect of flattening thereof on passage into the contact area.

Under the action of these circumferential forces, the segments 110 are compressed and bear against one another at the level of the incisions 104. This makes it possible, with the assistance of the frictional forces between the lips of the incisions 104, to prevent any circumferential or axial displacement of the junctions 106, with the harmful effect of causing deradialisation of the partitions 103 and hastening buckling thereof.

Thus, the annular body 102 behaves substantially as if no incision 104 had been made in the junctions 106, so benefiting from the structural advantages associated with this geometric configuration.

In order to achieve this property, it is necessary to adjust the distance in the circumferential direction between two incisions 104 such that there are always at least three complete segments 110 in contact with the internal part of the tire situated under the tread and in contact with the ground S.

Furthermore, the width d in the circumferential direction between the two lips of a single incision 104 has to be selected judiciously. Incisions 104 are preferably very narrow. A “very narrow” incision is an incision having width d that enables the operation described above with respect to FIG. 5. This dimension makes it possible, with the assistance of the frictional forces between the lips of the incisions 104, to prevent any circumferential or axial displacement of the junctions 106, with the harmful effect of causing deradialization of the partitions 103 and hastening buckling thereof. Stated in another way, a very narrow incision allows compression between the two lips of the incision in the contact patch under a radial load, or that with a very narrow incision, two adjacent segments behave as one on a flat track and under a radial load in the contact patch.

As low a value as possible for width d will be sought in order to benefit fully from the “buttressing” effect associated with compression of the segments. It has been observed experimentally that this distance d must not exceed 3 mm, and preferably a value of the distance d between 1 and 3 mm, on the order of 2 mm, will be selected.

The effect sought by the invention is apparent, on the other hand, when the tire enters into contact with the edge N of a pothole or of a kerb and during the combined compression phase, as illustrated in FIG. 6. In these circumstances, the force is confined to a generatrix of the cylinder formed by the crown of the support and is applied at the level of a single segment, or indeed between two consecutive segments. Furthermore, in the absence of flattening, the circumferential compression forces associated with deradialisation of the crown of the support are no longer exerted, no longer allowing cooperation between two consecutive segments, so causing buckling of the two partitions 103a and 103b situated either side of the incision 104a circumferentially closest to the point of impact, which has a tendency to open, as illustrated in FIG. 6. In fact, owing to the incision formed in the junction 106, the resistance to buckling of the partitions of these segments is less than in the case where no incision is provided. Consequently, under the action of a localized force, it is possible, during the phase of combined displacement of the support and the tire, to reduce the support compression phase and to prolong the effect of the pneumatic phase in order to reduce the mechanical forces transmitted to the wheel centre.

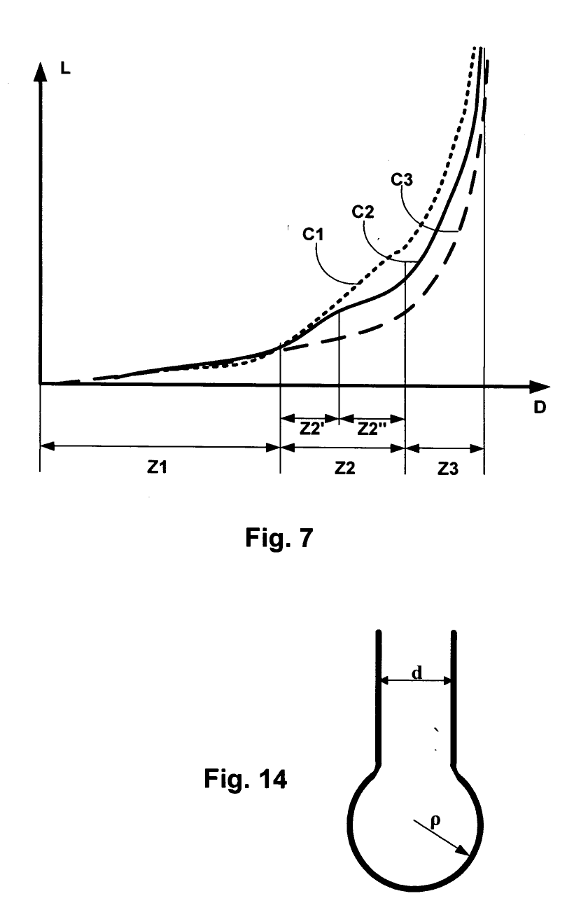

This phenomenon is illustrated in the diagram shown in FIG. 7, which shows on the y-axis the force L exerted at the wheel centre by the action of a punctiform obstacle, whose penetration distance D is plotted on the x-axis.

This diagram, obtained for a wheel of the dimension 235×500 A, a tire of the dimension 245×690×R500 and a support of the dimension 90-500(35), shows three configurations:
C1 shows the case of a wheel/tire assembly with a support not comprising any incisions,
C2 shows the case of a wheel/tire assembly with supports comprising incisions according to the invention; the circumferential profile of the partitions and junctions being identical to that of the support shown in C1,
C3 shows a wheel/tire assembly not comprising any support.

Very logically, driving in of the obstacle results in an increase in the recorded force, which makes it possible to distinguish between the three operating zones described above:
Z1 corresponds to the pneumatic phase of the driving-in process;
Z2 corresponds to the combined phase, during which the support enters into contact with the tire,
Z3 corresponds to non-pneumatic compression and ends in a purely mechanical transmission phase.

This diagram clearly reveals the mode of operation of a system equipped with a support according to the invention, for which there may be observed an operating zone Z1 similar to the other two, a zone Z2 which may be broken down into two very distinct phases, with Z2′ corresponding to compression of the partitions and Z2″ corresponding to the appearance of the phenomenon of buckling of the partitions 103 and 103b and to opening of the incision 104a, as illustrated in FIG. 6.

It will be noted that the support according to invention makes it possible substantially to reduce the support compression phase in zone Z2, so approaching that of a system not comprising any support as described by the curve C3, and moving away from the configuration of a support in which no incision has been formed, described by the curve C1, whose profile presents a greater force increase gradient in zone Z2 for the same displacement.

It is likewise possible, with reference to the configuration which has just been described and without going beyond the spirit of the invention, to reduce still further the energy required to cause buckling of the partitions subjected to a punctiform impact.

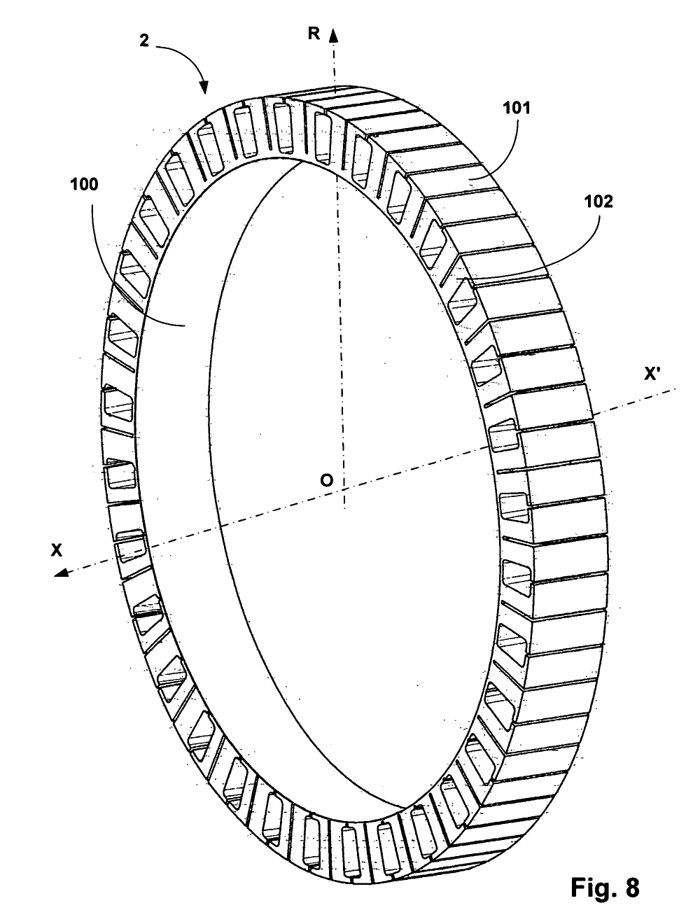

To this end, another embodiment of the invention consists in extending the incision 104 formed in the junction 106 by an incision 105 formed radially throughout the thickness of the crown of the support 2 and extending axially over the entire width of the latter, either side of the median plane passing substantially through the equator of the cylinders formed by the base 100 or the crown 101, whose path is represented on the section of FIG. 10 by the line MM′, and which is as illustrated in FIGS. 8, 9, 10 and 11.

This configuration makes it possible to reduce the structural resistance to buckling of the partitions 103, these no longer being connected together at the crown.

Under these conditions, the mode of operation during flat running is substantially equivalent to that described above, in which the partitions bear against one another under the action of the circumferential forces induced by deradialisation at the moment of flattening, on condition, as in the situation already described above, that three segments at least are present simultaneously in the contact patch, as shown in FIG. 12.

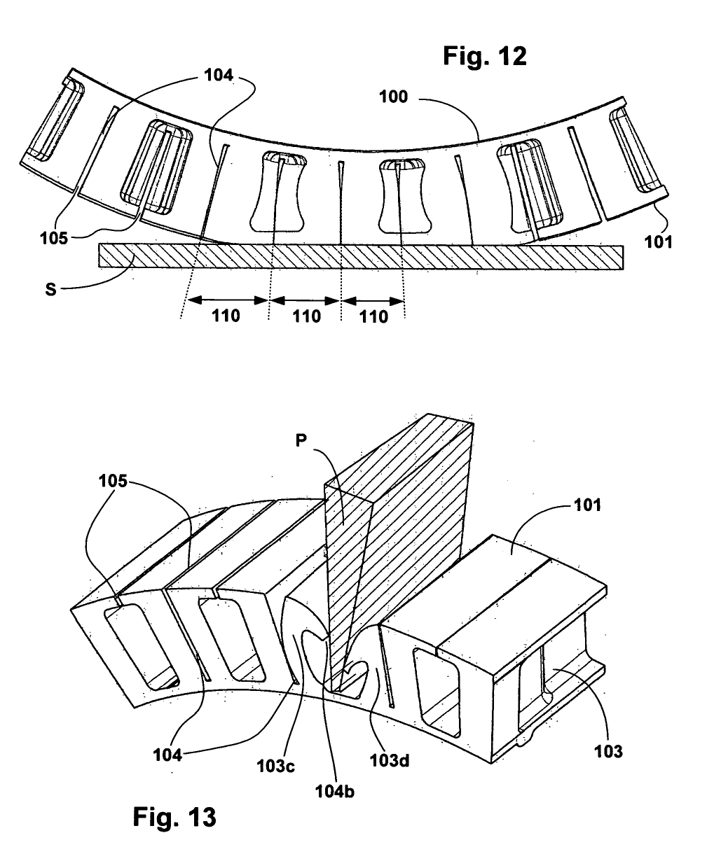

On the other hand, on passage through a pothole or over a kerb edge, as is illustrated in FIG. 13, the partitions 103c and 103d of the segments situated circumferentially either side of the incision 104b closest to the point of contact with the punctiform obstacle P have a tendency to buckle under a lower level of energy, and the incision 104b has a tendency to open wide to allow penetration of the obstacle P.

A third configuration, mid-way between the two described above, consists in making the incisions 105 open only into the median or central part of the crown of the support.

FIG. 14 shows a cross-section of a radial end of either one of the incisions 104 or 105 shown in the preceding figures. This transverse profile is obtained by cutting the incision through a cutting plane substantially transverse to the average direction of the incision.

In FIG. 14, as in the preceding figures, we see that the transverse width d of the incision is substantially constant along the entire radial height of the incision. This transverse width d in this case is on the order of 2 to 2.5 mm. This profile has at its radial end a bulge with a width greater than d. At this end, the transverse profile has curves p greater than one millimeter. In the example of FIG. 14, the bulge is toroid-shaped, with a radius on the order of two mm.

Of course, in the case of the incisions 104, which extend along the entire radial height of the annular body 102, this bulge is located at both the internal and external radial ends of the incision. Conversely, in the case of the incisions 105, which extend into the crown 101, there is only one bulge, located at the internal radial end.

When the incisions 105 open only into the median or center part of the crown of the support, on the lateral walls of the support, the incisions have two bulges, at both the internal and external ends.

The presence of these bulges makes it possible to substantially improve the strength of the support when running flat, while retaining excellent behavior upon impact with a wedge-like obstacle, for example.

The materials likely to be suitable for producing supports according to the invention are those which are conventionally used to produce run-flat supports, such as, by way of non-limiting example, rubber mixes whose modulus of elasticity may vary from 10 to 40 MPa, polyurethane elastomers having moduli of elasticity of between 20 and 150 MPa or, alternatively, thermoplastic elastomers whose modulus of elasticity is between 20 and 150 MPa.

The modulus of the elastomeric materials expressed in MPa corresponds to measurement under tension and at 10% elongation of a test specimen, in accordance with ISO Standard 6892 of 1984 and to the ASTM Standard D 412 of 1998, with regard to rubber compositions.

Finally, care should be taken to define the incisions formed in the partitions 103 or in the crown 105 such that they have the least possible undercut impeding demolding in the axial direction of the run-flat support and liable to complicate the manufacturing process.

Thus, implementation of the invention is particularly relevant to a configuration in which it is imperative to reduce the total mass of the support, which is achieved by using materials of a high modulus of elasticity. The downside of this technical choice is generally an increase in the radial rigidity of the support and a reduction in performance in the event of impact with a localized obstacle compared with the situation of a support made of a material of a lower modulus or alternatively with a situation in which no support is fitted. The invention makes it possible to improve the level of performance in the event of an accidental punctiform impact, while benefiting from the advantages associated with the structural configuration of conventional supports.

1. A run-flat support (1, 2) adapted to be mounted on a rim inside a tire fitted on a vehicle, to support the tread of said tire in the event of a loss of inflation pressure, comprising:
a substantially cylindrical base (100), adapted to conform to the rim,
a substantially cylindrical crown (101) adapted to enter into contact with the internal part of the tire situated under the tread in the event of a loss of pressure and leaving clearance relative thereto at the rated operating pressure of the tire, and
an annular body (102) linking the base and the crown, said body having a plurality of generally radial partitions (103), distributed over the circumference of said support and extending substantially axially, and of generally radial junctions (106), extending substantially circumferentially and connected by their ends to two adjacent partitions,
wherein the junctions (106) are interrupted by very narrow axial incisions (104) extending radially over the entirety of said junction (106) and opening axially on either side of said junctions (106), the support portion between two incisions constituting a segment (110), and in that, each incision being geometrically defined by a transverse profile obtained by cutting said incision through a cutting plane substantially transverse to the average direction of the incision, the transverse profile has at its radial end curves (ρ) greater than one mm.

2. The run-flat support according to claim 1, wherein the curves (ρ) are between:
$$\frac{d}{2} ≺ ρ ≺ d$$
where d is the transverse width of said incision.

3. The run-flat support according to claim 1, wherein the width (d) in the circumferential direction of the incisions (104) is less than 3 mm.

4. The run-flat support according to claim 3, wherein the width (3) in the circumferential direction of the incisions (104) is greater than 1 mm.

5. The run-flat support according to claim 1, wherein the distance in the circumferential direction between two incisions (104) is adjusted in such a way that, when the support is running under reduced or zero pressure and run-flat its rated load, there are always at least three complete segments (110) in contact with the internal part of the tire situated under the tread and in contact with the ground (S).

6. The run-flat support according to claim 1, wherein the radial incision (104) formed in the junction (106) is extended by an incision (105) formed radially throughout the thickness of the crown (101) of the support and extending axially in the central portion of said crown.

7. The run-flat support according to claim 1, wherein the radial incision (104) formed in the junction (106) is extended by an incision (105) formed radially throughout the thickness of the crown (101) of the support and extending axially over the entire width of said crown.

8. The run-flat support according to claim 1, wherein the shape of the partitions (103), the junctions (106) and the incisions (104, 105) is so adapted as not to comprise any undercut part impeding the axial demolding of the run-flat support (1, 2).

9. The support according to claim 1, wherein the material constituting said run-flat support (1, 2) is a rubber mix with a modulus of elasticity of between 10 and 40 MPa.

10. The support according to claim 1, wherein the material constituting said run-flat support (1, 2) is a polyurethane elastomer with a modulus of elasticity of between 20 and 150 MPa.

11. The support according to claim 1, wherein the material constituting said run-flat support (1, 2) is a thermoplastic elastomer with a modulus of elasticity of between 20 and 150 MPa.
